(19) United States
(12) Patent Application Publication
(10) Pub. No.: US 2006/0103986 A1
(43) Pub. Date: May 18, 2006

(54) Head drum assembly of magnetic recording and reproducing apparatus

(75) Inventors: Byeong-bae Park, Ansan-si (KR); Jeong-seon Kim, Suwon-si (KR); Jun-young Lee, Yongin-si (KR); Young-ho Cho, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/263,856

(22) Filed: Nov. 2, 2005

(30) Foreign Application Priority Data
Nov. 12, 2004 (KR) 2004-92584

(51) Int. Cl. G11B 5/52

(52) U.S. Cl. 360/271.8

(57) ABSTRACT

A head drum assembly for a magnetic recording and reproducing apparatus that records information onto a recording medium or reproduces the recorded information from the recording medium includes a stationary drum mounted to a deck chassis, a shaft fixed to a center portion of the stationary drum, a rotary drum rotatably fixed to the shaft and having a plurality of heads for recording and reproducing the information with respect to the recording medium, and an airflow groove disposed at an uppermost stream in a running direction of the recording medium and proximal where the stationary drum contacts the recording medium. The airflow groove communicates with an inner space of the stationary drum and an outer circumference of the stationary drum that is adjacent to the rotary drum. The air flowing between the stationary drum and the rotary drum during rotation of the rotary drum flows toward the recording medium through the airflow groove.

### CROSS-REFERENCE TO RELATED APPLICATIONS

This application claims the benefit under 35 U.S.C. § 119(a) of Korean Patent Application No. 2004-92584, filed Nov. 12, 2004, the entire contents of which are hereby incorporated by reference.

### BACKGROUND OF THE INVENTION

1. Field of the Invention

The present invention relates to a head drum assembly for a magnetic recording and reproducing apparatus, such as a video tape recorder (VTR) and a camcorder. The head drum assembly of the magnetic recording and reproducing apparatus records and reproduces information with respect to a magnetic tape.

2. Description of the Related Art

Generally, a magnetic recording and reproducing apparatus, such as a video tape recorder (VTR) and a camcorder, includes a deck mechanism that drives a recording medium along a predetermined running path to record information on the recording medium and to reproduce the recorded information from the recording medium. The deck mechanism includes a deck chassis, a head drum assembly rotatably mounted to the deck chassis to record and reproduce the information with respect to the recording medium, and a recording medium guiding means that brings the recording medium into contact with the head drum assembly to guide running of the recording medium. The head drum assembly generally records and reproduces the information through helical scanning. Therefore, the head drum assembly rotates while being slanted at a predetermined angle with respect to the deck chassis.

FIG. 1 illustrates a general head drum assembly 1.

As shown in the drawing, the head drum assembly 1 includes a stationary drum 11 mounted to a deck chassis (not shown), a shaft 10 fixed to a central portion of the stationary drum 11, a rotary drum 13 disposed above the stationary drum 11 and rotatably fit around the shaft 10, and a drum cover 14 fixed above the rotary drum 13.

A plurality of head windows 15 are disposed at certain intervals along a lower outer circumference of the rotary drum 13 to expose a plurality of magnetic heads 17 therethrough. As shown in FIG. 3, a head tip of the magnetic head 17 is protruded outside of the outer circumference of the rotary drum 13 by a predetermined distance measured in micrometers (μm).

The recording and reproducing operation of the above-structured head drum assembly 1 will be described hereinbelow.

As shown in FIG. 2, first, a recording medium 20, such as a magnetic tape, is brought into tight contact with the stationary drum 11 and the rotary drum 13 by a generally-known recording medium guiding means (not shown) along a guiding groove 18 formed on an outer circumference of the stationary drum 11 of the head drum assembly 1 to guide running of the recording medium.

The recording medium 20 is driven at constant speed by a capstan shaft (not shown) and a pinch roller (not shown). The capstan shaft is applied with a rotational force of constant speed by a capstan motor (not shown). The rotary drum 13 rotates faster than the recording medium 20.

The recording medium 20 runs in contact with the outer circumferences of the stationary drum 11 and the rotary drum 13, such that the magnetic head 17 records the information on the recording medium 20 or reproduces the recorded information from the recording medium 20.

In the conventional head drum assembly 1, however, since the plurality of magnetic heads 17 protrude from the outer circumference of the rotary drum 13, the respective magnetic heads 17 are repeatedly collided with the recording medium 20 during rotation of the rotary drum 13, thereby continuously generating vibration and noise. The vibration and noise are more severe at the beginning of contact between the magnetic heads 17 and the recording medium 20 than after the magnetic heads 17 have already contacted the recording medium 20.

More specifically, as shown in FIGS. 2 and 3, the magnetic heads 17 protrude from the outer circumference of the rotary drum 13. Therefore, a surface pressure, which is a force of pushing the recording medium 20 outwardly with respect to the outer circumferences of the rotary drum 13 and the stationary drum 11, is applied to a contacting surface of the recording medium 20 at the moment of initial contact between the magnetic heads 17 and the recording medium 20. However, the recording medium 20 is applied with tension by the recording medium guiding means, thereby tightly contacting the rotary drum 13 and the stationary drum 11. Accordingly, when the magnetic head 17 initially contacts the recording medium 20, the surface pressure of the magnetic head 17 applied to the contacting surface of the recording medium 20 conflicts with the tension of the recording medium 20. As a result, the recording medium 20 generates vibration and noise and driving of the recording medium 20 becomes unstable.

Additionally, when the rotary drum 13 rotates, inflow of air may happen through a gap between the rotary drum 13 and the stationary drum 11. This air may flow through an inner space 21 of the stationary drum 11, thereby causing noise.

Such vibration and noise not only offend ears of a user but participate in deterioration of the recording and reproducing performance because the noise may be recorded on the magnetic recording and reproducing apparatus through a microphone.

Accordingly, a need exists for an improved magnetic recording and reproducing apparatus that substantially eliminates vibration and noise generated during operation.

### SUMMARY OF THE INVENTION

Accordingly, an aspect of the present invention is to provide an improved head drum assembly for a magnetic recording and reproducing apparatus that substantially restrains vibration and noise generated during operation.

A head drum assembly for a magnetic recording and reproducing apparatus records information onto a recording medium or reproduces the recorded information from the recording medium. A stationary drum is mounted to a deck chassis. A shaft is fixed to a center portion of the stationary drum. A rotary drum is rotatably fixed to the shaft and has a plurality of heads for recording and reproducing the information with respect to the recording medium. An airflow groove is disposed at an uppermost stream in a running direction of the recording medium proximal where the stationary drum contacts the recording medium. The airflow groove communicates with an inner space of the stationary drum at an outer circumference of the stationary drum that is adjacent to the rotary drum.

The airflow groove is extended by a predetermined length from a line-contact point where the heads initially contact the recording medium in a running direction of the recording medium and in a direction opposite the running direction.

The airflow groove is opened toward a gap between the rotary drum and the stationary drum within a range of a guiding groove formed on the outer circumference of the stationary drum that guides running of the recording medium.

Other objects, advantages and salient features of the invention will become apparent from the following detailed description, which, taken in conjunction with the annexed drawings, discloses preferred embodiments of the invention.

### BRIEF DESCRIPTION OF THE DRAWING FIGURES

The above aspect and other features of the present invention will become more apparent by describing in detail exemplary embodiments thereof with reference to the attached drawing figures, wherein:

FIG. 1 is an elevational view in partial cross section of a head drum assembly in a conventional magnetic recording and reproducing apparatus;

FIG. 2 is a top plan view of the head drum assembly of FIG. 1;

FIG. 3 is an elevational view in cross section of portion ‘A’ of the head drum assembly of FIG. 2;

FIG. 4 is a perspective view of a head drum assembly for a magnetic recording and reproducing apparatus according to an exemplary embodiment of the present invention;

FIG. 5 is an elevational view in partial cross section of the head drum assembly of FIG. 4;

FIG. 6 is an exploded elevational view in partial cross section of the head drum assembly of FIG. 4;

FIG. 7 is a development view of an outer circumference of a stationary drum of the head drum assembly of FIG. 4;

FIG. 8 is a top plan view of the head drum assembly of FIG. 4; and

FIG. 9 is a top plan view of the stationary drum of the head drum assembly of FIG. 4.

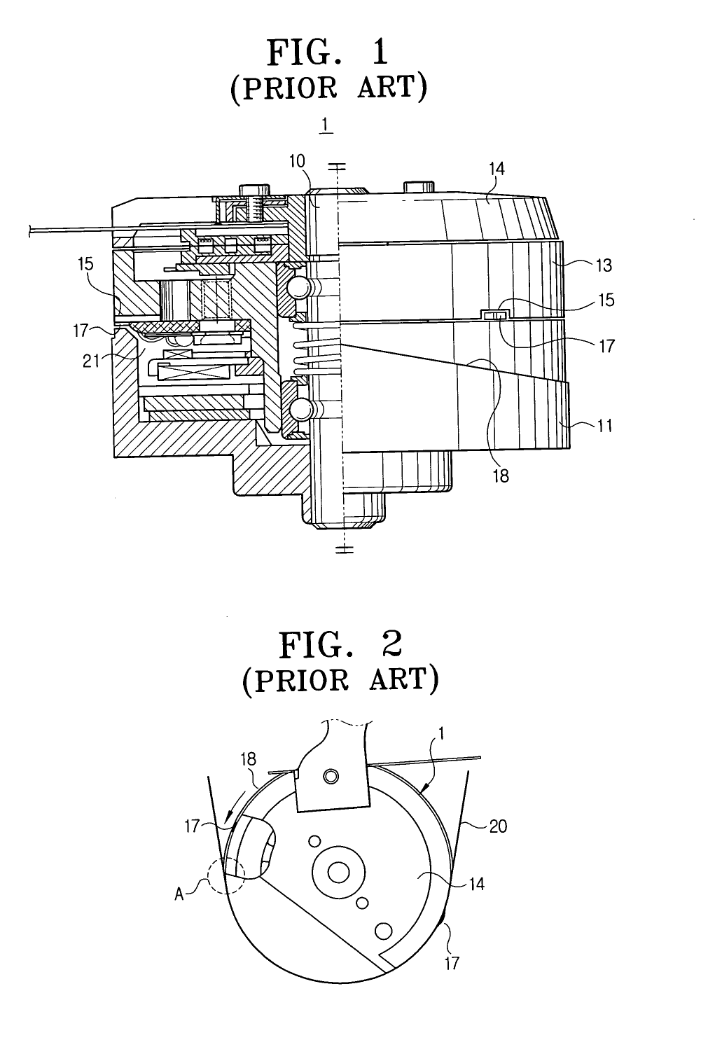

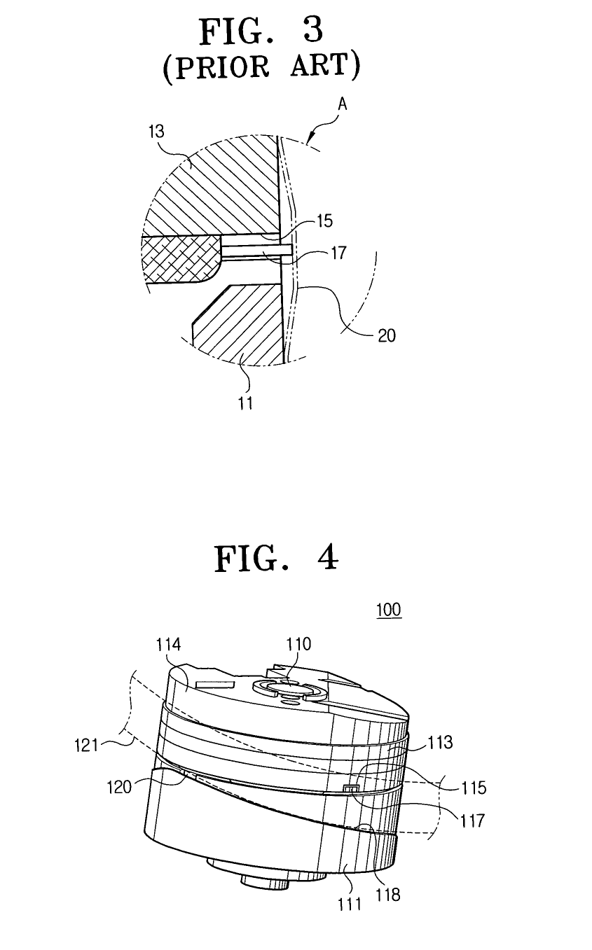

Throughout the drawings, like reference numerals will be understood to refer to like parts, components and structures.

### DETAILED DESCRIPTION OF EXEMPLARY EMBODIMENTS

Hereinafter, exemplary embodiments of the present invention are described in detail with reference to the accompanying drawing figures.

The matters defined in the description, such as a detailed construction and elements thereof, are provided to assist in a comprehensive understanding of the invention. Thus, it is apparent that the present invention may be carried out without those defined matters. Also, descriptions of well-known functions or constructions are omitted to provide a clear and concise description.

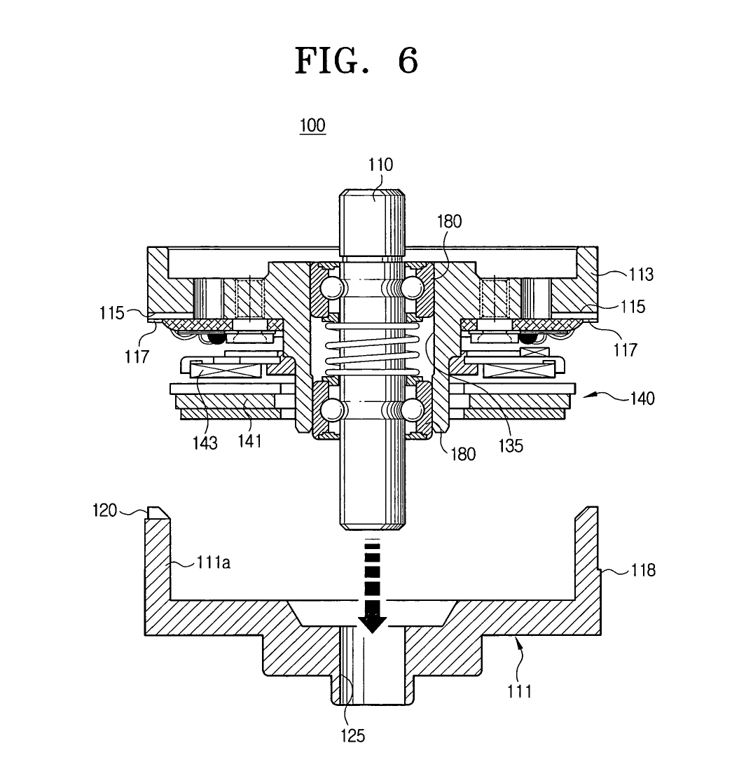

FIGS. 4 through 6 illustrate a head drum assembly of a magnetic recording and reproducing apparatus according to an exemplary embodiment of the present invention.

As shown in the drawings, a head drum assembly 100 of a magnetic recording and reproducing apparatus includes a stationary drum 111, a shaft 110, a rotary drum 113, and a drum cover 114.

The stationary drum 111 is mounted to a drum base (not shown) of a deck chassis (not shown) of the magnetic recording and reproducing apparatus. Also, the stationary drum 111 supports a stator 141 of a motor 140 that drives the rotary drum 113.

The shaft 110 is preferably press-fitted in a shaft hole 125 formed in the center of the stationary drum 111.

The rotary drum 113 is disposed above the stationary drum 111 and is rotatably supported by the shaft 110 through a bearing 180. A rotor 143 corresponding to the stator 141 is supported by the rotary drum 113. Accordingly, the rotary drum 113 is rotated at a high speed by driving the rotor 143 and the stator 141.

The drum cover 114 is disposed above the rotary drum 113. The drum cover 114 and the rotary drum 113 respectively support a stationary transfer 145 and a rotary transfer 147 for transmission of signals.

A plurality of magnetic heads 117 are disposed at certain intervals at a lower part of the rotary drum 113. The magnetic heads 117 are supported by the lower part of the rotary drum 113 facing an outer circumference 111a of the stationary drum 111. A head tip of each magnetic head protrudes outside of the outer circumference of the rotary drum 113 by a predetermined distance (preferably, a certain amount of micrometers (μm)) through head windows 115. The magnetic head 117 records or reproduces information with respect to a recording medium 121, such as a magnetic tape, which runs in contact with the rotary drum 113 and the stationary drum 111 through the head tip thereof.

The head drum assembly 100 of the magnetic recording and reproducing apparatus according to an exemplary embodiment of the present invention may be further provided with an airflow groove 120 at the stationary drum 111.

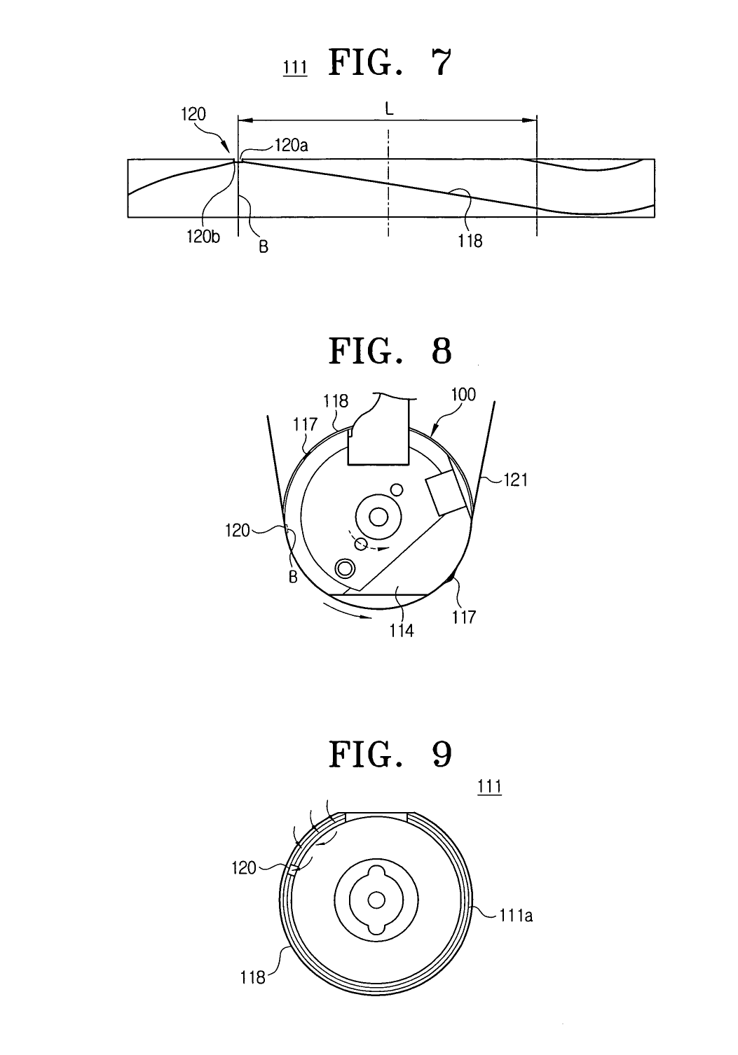

The airflow groove 120 restrains vibration and noise generated by initial contact between the magnetic heads 117 and the recording medium 121 when the rotary drum 113 rotates and also substantially reduces noise from airflow induced by the rotary drum 113. As shown in FIG. 7, the airflow groove 120 is disposed at the uppermost stream in a running direction of the recording medium within a recording medium contacting range L of the stationary drum 111. For example, the range L is preferably approximately 185˜190°. The uppermost stream refers to an initial line-contact point B where the respective magnetic heads 117 are first contacted with the recording medium 121 when the rotary drum 113 rotates. Also, the airflow groove 120 communicates with an inner space 122 at an upper part of the outer circumference 111a of the stationary drum 111 that is adjacent to the lower part of the rotary drum 113.

Further, the airflow groove 120 is extended by a predetermined length from the line-contact point B in the running direction of the recording medium and the opposite direction of the running direction, such that an inner portion 120a and an outer portion 120b of the airflow groove 120 that are respectively positioned inside and outside the recording medium contacting range L, are symmetrically formed.

Additionally, the airflow groove 120 is preferably opened toward a gap ‘D’ between the rotary drum 113 and the stationary drum 111, within a range of a guiding groove 118 formed on an outer circumference 111a of the stationary drum 111 to guide running of the recording medium.

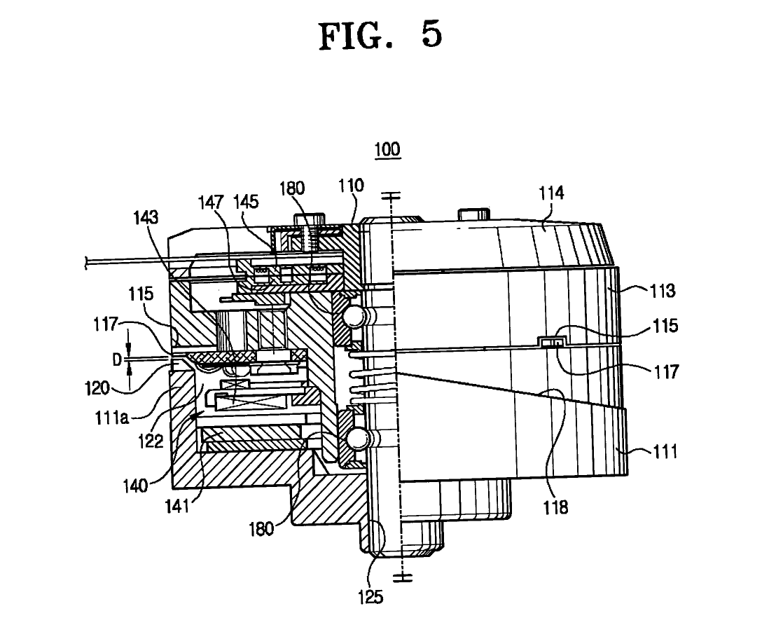

Therefore, as shown in FIGS. 8 and 9, when the rotary drum 113 rotates to record or reproduce the information with respect to the recording medium 121, the air drawn in through the gap ‘D’ (FIG. 5) between the stationary drum 111 and the rotary drum 113 and flowing to the inner space 122 of the stationary drum 111 is moved to the recording medium 121 at the initial line-contact point B where the airflow groove 120 is located to the recording medium 121. As a result, the tension of the recording medium 121 applied to the outer circumferences of the rotary drum 113 and the stationary drum 111 is temporarily attenuated, thereby reducing the noise generated by the air flowing between the rotary drum 113 and the stationary drum 111.

As the tension of the recording medium 121 is temporarily reduced, although the surface pressure is applied to the contacting surface of the recording medium 121 by the respective magnetic heads 117 when the respective magnetic heads 117 reach the initial line-contact point B to be contacted with the recording medium 121, the surface pressure pushing the recording medium 121 outward with respect to the outer circumferences of the rotary drum 113 and the stationary drum 111, an impact applied to the recording medium 121, may be considerably reduced. Consequently, unstable driving of the recording medium 121 due to the vibration and noise is substantially eliminated.

The operation of recording and reproducing of the above-structured head drum assembly 100 will be hereinbelow described.

As shown by a dotted line in FIG. 4, the recording medium 121 is tightly contacted with the outer circumferences of the stationary drum 111 and the rotary drum 113, being guided by a well-known recording medium guiding means (not shown) along the guiding groove 118 formed on the outer circumference of the stationary drum 111 of the head drum assembly 100.

The recording medium 121 is driven at constant speed by a capstan shaft (not shown), which is rotated by a rotational force of constant speed applied by a capstan motor (not shown), and a pinch roller (not shown). The rotary drum 113 rotates even faster than the recording medium 121.

As the rotary drum 113 rotates, as shown in FIG. 9, air flows in through the gap ‘D’ (FIG. 5) between the stationary drum 111 and the rotary drum 113. The air flows inside the rotary drum 113, and moves toward the recording medium 121 through the airflow groove 120, thereby pushing out the recording medium 121. As a result, the tension of the recording medium 121, which is applied to the outer circumferences of the stationary drum 111 and the rotary drum 113, is temporarily attenuated at the initial line-contact point B where the airflow groove 120 is disposed. Also, since the air that flows between the rotary drum 113 and the stationary drum 111 is discharged out of the stationary drum 111 through the airflow groove 120 at this time, the noise generated by the air may be reduced.

When the respective magnetic heads 117 reach the initial line-contact point B contacting the recording medium 121 by rotation of the rotary drum 113, the magnetic heads 117 apply surface pressure onto the contacting surface of the recording medium 121 to push the recording medium 121 outward with respect to the outer circumferences of the rotary drum 113 and the stationary drum 111. However, although the surface pressure of the magnetic heads 117 and the tension of the recording medium 121 act in opposite directions, the impact applied to the recording medium 121 is decreased because the tension of the recording medium 121 that is applied to the outer circumferences of the stationary drum 111 and the rotary drum 113 has been attenuated by the airflow. Therefore, the unstable driving of the recording medium 21 due to the vibration and noise is substantially eliminated.

The magnetic heads 117 are continuously rotated by the rotary drum 113 to repeat recording or reproducing of information with respect to the recording medium 121 that is run in contact with the outer circumference of the rotary drum 113.

As may be appreciated from the above description, in the head drum assembly of the magnetic recording and reproducing apparatus according to an exemplary embodiment of the present invention, the air flowing inside the rotary drum 113 during rotation of the rotary drum 113 flows toward the recording medium 121 through the airflow groove 120 that is preferably formed at the uppermost stream of the stationary drum 111 with respect to the running direction of the recording medium 121, and where the stationary drum 111 contacts the recording medium 121. Accordingly, the tension of the recording medium 121 that is applied to the magnetic heads 117 is attenuated, thereby substantially reducing the vibration and noise generated between the magnetic heads 117 and the recording medium 121 when the magnetic heads 117 initially contact the recording medium 121. As a result, driving of the recording medium 121 is stabilized and accordingly, recording and reproducing performance of the magnetic recording and reproducing apparatus is enhanced.

Furthermore, in the head drum assembly according to an exemplary embodiment of the present invention, the air flowing by rotation of the rotary drum 113 between the rotary drum 113 and the stationary drum 111 is discharged to the outside of the stationary drum 111 through the airflow groove 120. Therefore, the noise caused by the air between the rotary drum 113 and the stationary drum 111 may be reduced.

While the invention has been shown and described with reference to certain embodiments thereof, it will be understood by those skilled in the art that various changes in form and details may be made therein without departing from the spirit and scope of the invention as defined by the appended claims.

What is claimed is:

1. A head drum assembly for a magnetic recording and reproducing apparatus that records information onto a recording medium or reproduces the recorded information from the recording medium, comprising:
a stationary drum mounted to a deck chassis;
a shaft fixed to a center portion of the stationary drum;
a rotary drum rotatably fixed to the shaft and having a plurality of heads for recording and reproducing the information with respect to the recording medium; and
an airflow groove disposed at an uppermost stream of the stationary drum contacting the recording medium in a running direction of the recording medium and communicating with an inner space of the stationary drum at an outer circumference of the stationary drum adjacent to the rotary drum.

2. The head drum assembly of claim 1, wherein
the airflow groove is extended by a predetermined length from a line-contact point where the heads initially contact the recording medium during the rotation of the rotary drum in a running direction of the recording medium and in the opposite direction of the running direction.

3. The head drum assembly of claim 1, wherein
the airflow groove is opened toward a gap between the rotary drum and the stationary drum within a range of a guiding groove formed on the outer circumference of the stationary drum that guides running of the recording medium.

4. The head drum assembly of claim 2, wherein
the airflow groove is opened toward a gap between the rotary drum and the stationary drum, within a range of a guiding groove formed on the outer circumference of the stationary drum that guides running of the recording medium.

5. The head drum assembly of claim 1, wherein
the plurality of heads extend beyond the outer circumference of the rotary drum.

6. The head drum assembly of claim 5, wherein
a tip of each of the plurality of heads is adapted to contact the recording medium.

7. A method of reducing tape tension in a recording medium contacting a head drum assembly of a magnetic recording and reproducing apparatus, comprising the steps of
drawing air into an inner space of a stationary drum during rotation of a rotary drum;
moving air from the inner space to an airflow groove in the stationary drum; and
discharging air from the airflow groove into the recording medium traveling in a guiding groove formed in the stationary drum.

8. A method of reducing tape tension in a recording medium contacting a head drum assembly of a magnetic recording and reproducing apparatus according to claim 7, further comprising
drawing air into the inner space of the stationary drum through a gap formed between the stationary and rotary drums.

9. A method of reducing tape tension in a recording medium contacting a head drum assembly of a magnetic recording and reproducing apparatus according to claim 7, further comprising
discharging air from the airflow groove proximal where a head of the rotary drum initially contacts the recording medium.

10. A method of reducing tape tension in a recording medium contacting a head drum assembly of a magnetic recording and reproducing apparatus according to claim 7, further comprising
disposing the airflow groove within a contact range of the recording medium with the stationary drum.

11. A method of reducing tape tension in a recording medium contacting a head drum assembly of a magnetic recording and reproducing apparatus according to claim 7, further comprising
extending the airflow groove a substantially equivalent circumferential distance from a point where a head of the rotary drum initially contacts the recording medium.
